(19) United States
(12) Patent Application Publication
(10) Pub. No.: US 2021/0148320 A1
(43) Pub. Date: May 20, 2021

(54) ELECTROMAGNETIC VALVE AND HIGH-PRESSURE PUMP HAVING THE SAME

(71) Applicant: DENSO CORPORATION, Kariya-city (JP)

(72) Inventor: Yoshifumi IWATA, Kariya-city (JP)

(21) Appl. No.: 16/950,191

(22) Filed: Nov. 17, 2020

(30) Foreign Application Priority Data
Nov. 19, 2019 (JP) 2019-208862

(51) Int. Cl. F02M 59/46; F02M 59/36

(52) U.S. Cl. CPC F02M 59/466; F02M 2200/502; F02M 59/368

(57) ABSTRACT

A shaft of a valve element has an outer peripheral wall that is slidable along an inner peripheral wall of a cylinder while the shaft is supported by the cylinder so as to enable reciprocation of the shaft in an axial direction. An inner peripheral wall of the armature is slidable along an outer peripheral wall of a valve umbrella of the valve element, and the armature is configured to abut against a surface of the valve element, which is located on a side that is opposite to a valve portion of the valve element. An inner stator is placed on a side of the armature, which is opposite to the valve element. A coil is configured to generate a magnetic flux to magnetically attract the armature toward the inner stator when the coil is energized.

### CROSS REFERENCE TO RELATED APPLICATION

This application is based on and incorporates herein by reference Japanese Patent Application No. 2019-208862 filed on Nov. 19, 2019.

### TECHNICAL FIELD

The present disclosure relates to an electromagnetic valve and a high-pressure pump having the same.

### BACKGROUND

Previously, there is proposed a high-pressure pump that pressurizes fuel and supplies the pressurized fuel to an internal combustion engine. The high-pressure pump includes an electromagnetic valve and adjusts the amount of fuel to be pressurized through the electromagnetic valve.

The electromagnetic valve includes: a valve element, which is shaped in a rod form and is configured to open and close a passage for conducting fuel; and an armature, which is shaped in a bottomed tubular form and is configured to move relative to the valve element in an axial direction. The valve element has an outer peripheral wall that is slidable along an inner peripheral wall of a cylinder, and the valve element is supported by the cylinder so as to enable reciprocation of the valve element in the axial direction. The armature has an outer peripheral wall that is slidable along an inner peripheral wall of a stator, and the armature is supported by the stator so as to enable reciprocation of the armature in the axial direction. Here, the outer peripheral wall of the valve element and an inner peripheral wall of the armature do not slide relative to each other.

### SUMMARY

An electromagnetic valve of the present disclosure includes a cylinder, a valve element and an armature. The cylinder includes: a liquid passage, which is configured to conduct liquid; and a valve seat, which is formed around the liquid passage. The valve element includes: a valve portion; a shaft, which extends from the valve portion in an axial direction and has an outer peripheral wall that is slidable along an inner peripheral wall of the cylinder, wherein the shaft is supported by the cylinder so as to enable reciprocation of the shaft in the axial direction; and a valve umbrella, which is formed integrally with the shaft, wherein the valve element is configured to open or close the liquid passage when the valve portion is lifted away from the valve seat in a valve opening direction or is seated against the valve seat in a valve closing direction. The armature is configured to move relative to the valve element while an inner peripheral wall of the armature is slidable along an outer peripheral wall of the valve umbrella.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic cross-sectional view showing an electromagnetic valve and a high-pressure pump according to a first embodiment.

FIG. 2 is a cross-sectional view showing the electromagnetic valve according to the first embodiment.

FIG. 3 is a cross-sectional view taken along line III-III in FIG. 2, showing a valve element of the electromagnetic valve according to the first embodiment.

FIG. 4 is a cross-sectional view showing the electromagnetic valve according to the first embodiment, indicating an operational state of the electromagnetic valve and the high-pressure pump.

FIG. 5 is a cross-sectional view showing the electromagnetic valve according to the first embodiment, indicating another operational state of the electromagnetic valve and the high-pressure pump.

FIG. 6 is a cross-sectional view showing the electromagnetic valve according to the first embodiment, indicating a further operational state of the electromagnetic valve and the high-pressure pump.

FIG. 7 is a diagram indicating exemplary operations of the electromagnetic valve and the high-pressure pump according to the first embodiment.

FIG. 8 is a cross-sectional view showing an electromagnetic valve according to a second embodiment.

FIG. 9 is a cross-sectional view showing an electromagnetic valve according to a third embodiment.

FIG. 10 is a cross-sectional view taken along line X-X in FIG. 9, showing a valve element of the electromagnetic valve according to the third embodiment.

FIG. 11 is a view taken in a direction of an arrow XI in FIG. 9, showing a valve umbrella of the valve element of the electromagnetic valve according to the third embodiment.

FIG. 12 is a diagram indicating a valve umbrella of a valve element of an electromagnetic valve according to a fourth embodiment.

FIG. 13 is a cross-sectional view showing an electromagnetic valve according to a fifth embodiment.

FIG. 14 is a cross-sectional view showing an electromagnetic valve according to a sixth embodiment.

FIG. 15 is a cross-sectional view showing an electromagnetic valve according to seventh and eighth embodiments.

FIG. 16 is a cross-sectional view showing an electromagnetic valve according to a ninth embodiment.

FIG. 17 is a cross-sectional view showing an electromagnetic valve according to a tenth embodiment.

### DETAILED DESCRIPTION

Previously, there is proposed a high-pressure pump that pressurizes fuel and supplies the pressurized fuel to an internal combustion engine. The high-pressure pump includes an electromagnetic valve and adjusts the amount of fuel to be pressurized through the electromagnetic valve.

The electromagnetic valve includes: a valve element, which is shaped in a rod form and is configured to open and close a passage for conducting fuel; and an armature, which is shaped in a bottomed tubular form and is configured to move relative to the valve element in an axial direction. The valve element has an outer peripheral wall that is slidable along an inner peripheral wall of a cylinder, and the valve element is supported by the cylinder so as to enable reciprocation of the valve element in the axial direction. The armature has an outer peripheral wall that is slidable along an inner peripheral wall of a stator, and the armature is supported by the stator so as to enable reciprocation of the armature in the axial direction. Here, the outer peripheral wall of the valve element and an inner peripheral wall of the armature do not slide relative to each other.

In the electromagnetic valve, a sliding distance, along which the armature and the stator slide relative to each other, is relatively large. Therefore, wearing of the armature and the stator may possibly be promoted. Furthermore, in the electromagnetic valve, the outer peripheral wall of the armature slides along the inner peripheral wall of the stator. Therefore, a size of the armature may possibly be increased in comparison to a case where the inner peripheral wall of the armature slides along an outer peripheral wall of another member.

An electromagnetic valve of the present disclosure includes a cylinder, a valve element, an armature, an armature spring, a valve element spring, a stator and a coil. The cylinder includes: a liquid passage, which is configured to conduct liquid; and a valve seat, which is formed around the liquid passage. The valve element includes: a valve portion; a shaft, which extends from the valve portion in an axial direction and has an outer peripheral wall that is slidable along an inner peripheral wall of the cylinder, wherein the shaft is supported by the cylinder so as to enable reciprocation of the shaft in the axial direction; and a valve umbrella, which is formed integrally with the shaft, wherein the valve element is configured to open or close the liquid passage when the valve portion is lifted away from the valve seat in a valve opening direction or is seated against the valve seat in a valve closing direction.

The armature is configured to move relative to the valve element while an inner peripheral wall of the armature is slidable along an outer peripheral wall of the valve umbrella. The armature is configured to abut against a surface of the valve element, which is located on a side that is opposite to the valve portion. The armature spring is configured to urge the armature in the valve opening direction. The valve element spring is configured to urge the valve element in the valve closing direction. The stator is located on a side of the armature, which is opposite to the valve element. The coil is configured to generate a magnetic flux to magnetically attract the armature toward the stator when the coil is energized.

In the present disclosure, when the armature is magnetically attracted to the stator in response to electric power supply to the coil, the valve element is urged in the valve closing direction by the valve element spring and is moved together with the armature in the valve closing direction. At this time, the slide movement does not occur between the inner peripheral wall of the armature and the outer peripheral wall of the valve umbrella of the valve element. When the valve portion of the valve element contacts the valve seat and is placed in a valve closing state, movement of the valve element in the valve closing direction is limited. In this state, when the armature is further magnetically attracted toward the stator, the armature is moved relative to the valve element. At this time, the slide movement occurs between the inner peripheral wall of the armature and the outer peripheral wall of the valve umbrella of the valve element. As discussed above, in the present disclosure, the slide movement between the inner peripheral wall of the armature and the outer peripheral wall of the valve umbrella of the valve element occurs only when the relative movement occurs between the armature and the valve element. Therefore, the sliding distance between the members can be reduced in comparison to the conventional electromagnetic valve discussed above. Thereby, the wearing of the member(s) can be reduced.

Furthermore, in the present disclosure, the slide movement occurs between the inner peripheral wall of the armature and the outer peripheral wall of the valve umbrella of the valve element. Thus, for the same L/D ratio (length to diameter ratio), it is possible to reduce L, which is the length measured in the axial direction, to allow a reduction in the axial size of the armature in comparison to the conventional configuration, in which the slide movement occurs between the outer peripheral wall of the armature and the inner peripheral wall of the other member like in the conventional electromagnetic valve. Thereby, the size of the electromagnetic valve can be reduced.

Hereinafter, an electromagnetic valve and a high-pressure pump of various embodiments will be described with reference to the drawings. In the following embodiments, the substantially same components are denoted by the same reference signs, and the description thereof will be omitted.

### First Embodiment

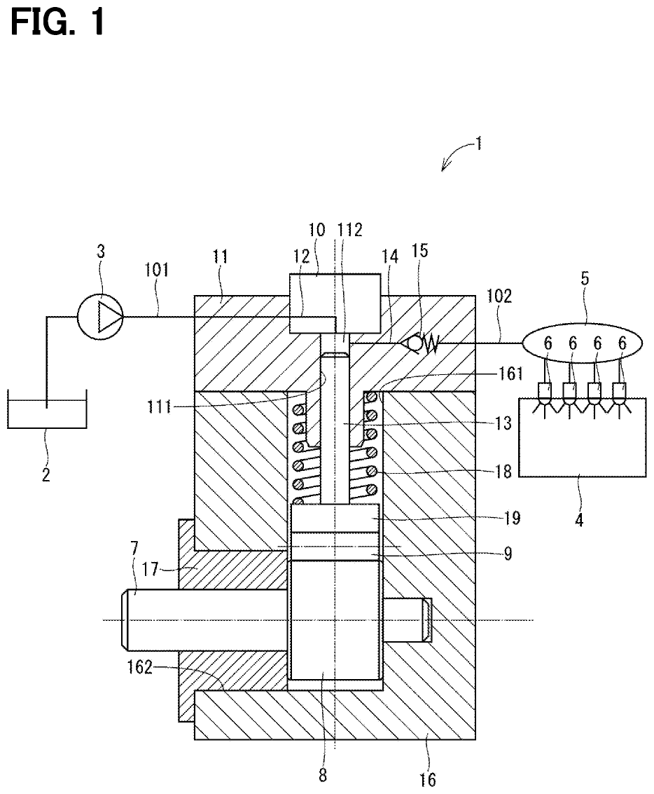

FIG. 1 indicates an electromagnetic valve and a high-pressure pump according to a first embodiment. The high-pressure pump 1 of the present embodiment is installed to, for example, a vehicle (not shown), and the high-pressure pump 1 pressurizes fuel to a predetermined pressure and supplies the pressurized fuel to an internal combustion engine (hereinafter referred to as an engine) 4. Here, the engine 4 is, for example, a diesel engine.

As shown in FIG. 1, the high-pressure pump 1 includes an electromagnetic valve (also referred to as a solenoid valve) 10, a pump body 11, a suction passage 12, a plunger 13 and a discharge passage 14.

The pump body 11 is made of, for example, metal and is installed to a housing 16 of the engine 4. The pump body 11 has a plunger hole 111. The plunger 13 is received in the plunger hole 111 and is configured to reciprocate in an axial direction in the plunger hole 111.

The electromagnetic valve 10 is installed to the pump body 11 such that the electromagnetic valve 10 is placed on an upper side of the plunger hole 111 in a vertical direction. The pump body 11 has a pressurizing chamber 112 that is located between the plunger 13 in the plunger hole 111 and the electromagnetic valve 10. When the plunger 13 reciprocates in the axial direction, a volume of the pressurizing chamber 112 is increased and is decreased.

A tappet 19 is fixed to an end part of the plunger 13, which is opposite to the pressurizing chamber 112. A return spring 18 is placed between the tappet 19 and the pump body 11. The return spring 18 is configured to urge the tappet 19 and the plunger 13 toward a side that is opposite to the pressurizing chamber 112.

The housing 16 is made of, for example, metal and has an installation hole 161 and a shaft hole 162. The installation hole 161 opens at, for example, an upper surface of the housing 16, which is located on an upper side in the vertical direction. The shaft hole 162 is connected to, for example, an opposite end part of the installation hole 161, which is opposite to the opening of the installation hole 161, such that the shaft hole 162 extends in a direction that is perpendicular to the installation hole 161 and opens at an outer wall of the housing 16.

A sealing element 17 is installed to an opening of the shaft hole 162. A camshaft 7 is installed to the housing 16. The camshaft 7 is rotatably supported by the housing 16 and the sealing element 17. A cam 8 is placed at an intersection between the installation hole 161 and the shaft hole 162. The cam 8 is formed at the camshaft 7 such that the cam 8 is rotatable integrally with the camshaft 7. The cam 8 is formed such that a radial distance, which is measured from a center to an outer peripheral wall of the cam 8 in a radial direction, smoothly changes in a circumferential direction.

The pump body 11 is installed to the upper surface of the housing 16, which is located on the upper side in the vertical direction, such that the plunger hole 111 is communicated with the installation hole 161, and a portion of the plunger 13, the tappet 19 and the return spring 18 are located in the installation hole 161.

A roller 9 is placed between the cam 8 and the tappet 19. The roller 9 is configured to rotate between the cam 8 and the tappet 19 when the cam 8 is rotated. When the camshaft 7 is rotated through rotation of the engine 4, the plunger 13 is reciprocated in the axial direction. In this way, a volume of the pressurizing chamber 112 is repeatedly increased and decreased.

A fuel tank 2, which stores the fuel, is connected to the high-pressure pump 1 through a pipe 101. A low-pressure pump 3 is installed to the pipe 101. The low-pressure pump 3 is rotated through, for example, the rotation of the engine 4 to suction the fuel from the fuel tank 2 and supply the suctioned fuel to the high-pressure pump 1. The suction passage 12 communicates between the pipe 101 and the pressurizing chamber 112.

A common rail 5, which is configured to store the fuel pressurized by the high-pressure pump 1, is provided to the engine 4. For example, four fuel injection valves 6 are connected to the common rail 5. Each of the fuel injection valves 6 is installed to the engine 4 such that an injection hole of the fuel injection valve 6 is exposed in a corresponding combustion chamber of the engine 4. The high-pressure pump 1 is connected to the common rail 5 through a pipe 102.

The discharge passage 14 communicates between the pressurizing chamber 112 and the pipe 102. A discharge valve 15 is installed to the discharge passage 14.

When the engine 4 is rotated, the low-pressure pump 3 suctions the fuel from the fuel tank 2 and supplies the suctioned fuel to the high-pressure pump 1 through the pipe 101. Here, in a valve opening state of the electromagnetic valve 10, when the plunger 13 is moved in a direction for increasing a volume of the pressurizing chamber 112, the fuel in the suction passage 12 is suctioned into the pressurizing chamber 112.

Then, in a valve closing state of the electromagnetic valve 10, when the plunger 13 is moved in a direction for decreasing the volume of the pressurizing chamber 112, the fuel is pressurized in the pressurizing chamber 112. When the pressure of the fuel in the pressurizing chamber 112 becomes equal to or higher than a predetermined pressure, the discharge valve 15 is placed in the valve opening state. Therefore, the fuel in the pressurizing chamber 112 is supplied to the common rail 5 through the discharge passage 14 and the pipe 102. The fuel, which is supplied to the common rail 5 and has the predetermined pressure, is injected from the fuel injection valves 6 into the combustion chambers of the engine 4.

Next, the structure of the electromagnetic valve 10 will be described in detail.

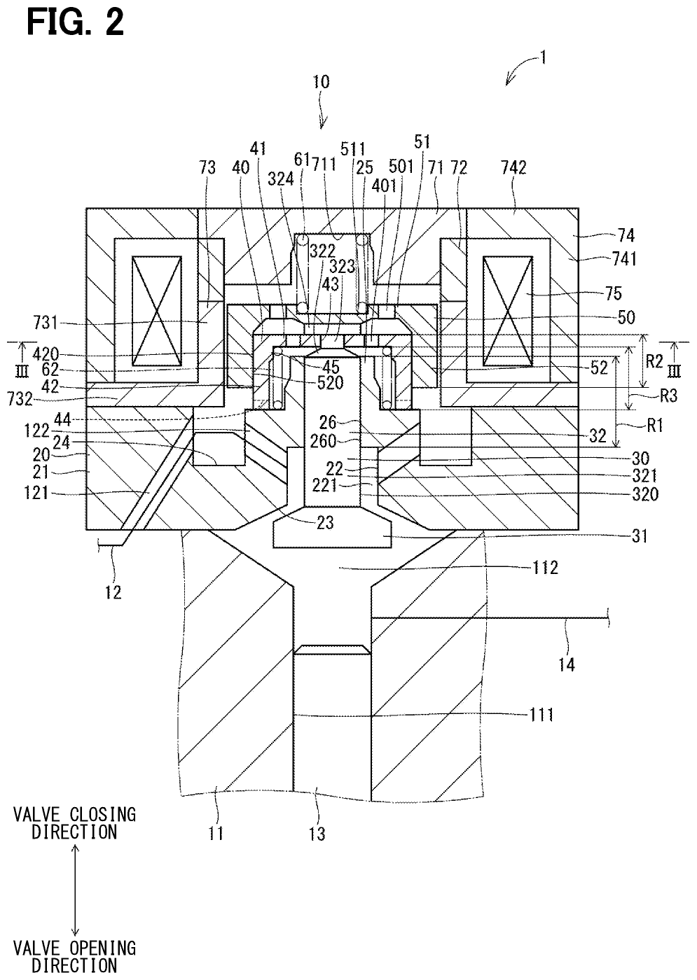

As shown in FIG. 2, the electromagnetic valve 10 includes a cylinder 20, a valve element 30, an armature 50, an armature spring 61, a valve element spring 62, an inner stator (serving as a stator) 71 and a coil 75.

The cylinder 20 has a cylinder main body 21, a cylinder hole 22, a fuel passage (serving as a liquid passage) 221, a valve seat 23, a cylinder annular recess 24, a cylinder projection 25 and a cylinder shaft hole 26.

The cylinder main body 21 is made of, for example, metal and is shaped in a circular plate form. The cylinder hole 22 is recessed in a circular form at a center part of one end surface of the cylinder main body 21. The fuel passage 221 is formed at an inside of the cylinder hole 22. The valve seat 23 is formed around the cylinder hole 22 at the one end surface of the cylinder main body 21 such that the valve seat 23 is recessed from the one end surface of the cylinder main body 21 in a tapered form. Specifically, the valve seat 23 is formed around the fuel passage 221. The fuel (serving as liquid) flows in the fuel passage 221.

The cylinder annular recess 24 is recessed in an annular form at the other end surface of the cylinder main body 21, which is opposite to the one end surface of the cylinder main body 21. Here, the cylinder annular recess 24 is formed on the radially outer side of the cylinder hole 22 such that the cylinder annular recess 24 is coaxial with the cylinder hole 22.

The cylinder projection 25 is formed integrally with the cylinder main body 21 in one-piece such that the cylinder projection 25 is shaped generally in a cylindrical rod form and projects from a center part of the other end surface of the cylinder main body 21. The cylinder projection 25 is coaxial with the cylinder hole 22.

The cylinder shaft hole 26 extends through the cylinder main body 21 and the cylinder projection 25 in the axial direction. The cylinder shaft hole 26 is coaxial with the cylinder hole 22. The cylinder shaft hole 26 has an inner peripheral wall 260, which is an inner peripheral wall of the cylinder 20 and is shaped in a cylindrical form.

A suction passage 121 and a suction passage 122, which are parts of the suction passage 12, are formed at the cylinder main body 21. The suction passage 121 connects between the one end surface of the cylinder main body 21 and the cylinder annular recess 24. The suction passage 122 connects between the cylinder annular recess 24 and the fuel passage 221. Thereby, the fuel, which is supplied to the high-pressure pump 1 through the pipe 101, can flow to the fuel passage 221 through the suction passage 121, the cylinder annular recess 24 and the suction passage 122.

The cylinder 20 is installed to the pump body 11 such that the one end surface of the cylinder main body 21 contacts an upper surface of the pump body 11, which is located on the upper side in the vertical direction, and the valve seat 23 is exposed in the pressurizing chamber 112 of the pump body 11.

The valve element 30 includes a valve portion 31, a shaft 32 and a valve umbrella 40. The valve portion 31 is made of, for example, metal and is shaped in a circular plate form. An outer peripheral part of one end surface of the valve portion 31 is shaped in a tapered form.

The shaft 32 is formed integrally with the valve portion 31 in one-piece such that the shaft 32 is shaped generally in a cylindrical rod form and extends in the axial direction from a center part of the one end surface of the valve portion 31. Specifically, the shaft 32 is formed integrally with the valve portion 31 in one-piece from the common material.

The shaft 32 includes a large diameter portion 321, a diameter reducing portion 322, a small diameter portion 323 and a flange 324. The large diameter portion 321 is formed integrally with the valve portion 31 in one-piece such that the large diameter portion 321 is shaped generally in a cylindrical rod form and extends in the axial direction from a center part of the one end surface of the valve portion 31. The diameter reducing portion 322 is formed integrally with the large diameter portion 321 in one-piece such that the diameter reducing portion 322 extends in the axial direction from an end part of the large diameter portion 321, which is opposite to the valve portion 31. The diameter reducing portion 322 is shaped in a tapered form such that an outer diameter of the diameter reducing portion 322 is progressively reduced in a direction away from the large diameter portion 321.

The small diameter portion 323 is formed integrally with the diameter reducing portion 322 in one-piece such that the small diameter portion 323 extends in the axial direction from an end part of the diameter reducing portion 322, which is opposite to the large diameter portion 321. An outer diameter of the small diameter portion 323 is smaller than an outer diameter of the large diameter portion 321. The flange 324 is formed integrally with the small diameter portion 323 in one-piece such that the flange 324 is shaped in a ring plate form and radially outwardly extends from an end part of the small diameter portion 323, which is opposite to the diameter reducing portion 322.

The valve element 30 is installed to the cylinder 20 such that the shaft 32 is placed at the inside of the cylinder shaft hole 26. Here, the shaft 32 has an outer peripheral wall 320 that is slidable along an inner peripheral wall 260 of the cylinder 20, and the shaft 32 is supported by the cylinder 20 so as to enable reciprocation of the shaft 32 in the axial direction.

The valve umbrella 40 includes a valve umbrella bottom portion 41, a valve umbrella tubular portion 42, a valve umbrella hole 43, a plurality of grooves 44, a spring movement limiter 45, a cutout 46 and a plurality of valve umbrella projections 47. The valve umbrella bottom portion 41 is shaped in a circular plate form and is made of, for example, metal. The valve umbrella tubular portion 42 is formed integrally with the valve umbrella bottom portion 41 in one-piece such that the valve umbrella tubular portion 42 is shaped in a cylindrical tubular form and extends in the axial direction from an outer peripheral part (radially outer end part) of the valve umbrella bottom portion 41. Specifically, the valve umbrella tubular portion 42 is formed integrally with the valve umbrella bottom portion 41 in one-piece from a common material.

The valve umbrella hole 43 extends in a circular form through a center part of the valve umbrella bottom portion 41 in a plate thickness direction of the valve umbrella bottom portion 41 (i.e., a direction perpendicular to a plane of the valve umbrella bottom portion 41). Each of the grooves 44 is recessed in the axial direction at an end surface of the valve umbrella tubular portion 42, which is opposite to the valve umbrella bottom portion 41. Each groove 44 is configured to communicate between an inside and an outside of the valve umbrella tubular portion 42. The grooves 44 are arranged one after another in the circumferential direction of the valve umbrella tubular portion 42.

The spring movement limiter 45 is shaped in a cylindrical tubular form and radially inwardly extends from an end part of the valve umbrella tubular portion 42, which is located on the side where the valve umbrella bottom portion 41 is placed. Specifically, an inner diameter of the spring movement limiter 45 is smaller than an inner diameter of the valve umbrella tubular portion 42.

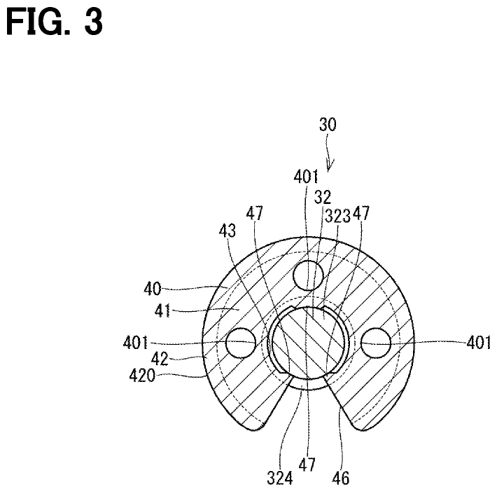

As shown in FIG. 3, the cutout 46 is shaped such that a circumferential part of the valve umbrella bottom portion 41 and a circumferential part of the valve umbrella tubular portion 42 are cut and removed. Therefore, the cutout 46 is connected to the valve umbrella hole 43. The valve umbrella projections 47 project radially inwardly from the valve umbrella hole 43. The number of the valve umbrella projections 47 is three, and the valve umbrella projections 47 are arranged one after another in the circumferential direction of the valve umbrella hole 43.

The valve umbrella 40 is integrated with the shaft 32 such that the small diameter portion 323 contact the valve umbrella projections 47 at the inside of the valve umbrella hole 43.

The valve umbrella 40 and the shaft 32 are assembled as follows. Specifically, the small diameter portion 323 of the shaft 32 is slid toward the valve umbrella hole 43 through the cutout 46 and is fitted to the inside of the valve umbrella hole 43 such that the small diameter portion 323 contacts the three valve umbrella projections 47.

As shown in FIG. 2, the end surface of the valve umbrella tubular portion 42 of the valve umbrella 40, which is opposite to the valve umbrella bottom portion 41, is configured to contact a portion of the other end surface of the cylinder main body 21, which is opposite to the pump body 11, at a location that is between the cylinder annular recess 24 and the cylinder projection 25. Specifically, among the valve umbrella 40 and the cylinder 20, the valve umbrella 40 has the grooves 44 that are recessed in the axial direction at the contact part where the valve umbrella 40 and the cylinder 20 contact with each other when the valve umbrella 40 abuts against the cylinder 20.

In a state where the end surface of the valve umbrella tubular portion 42 contacts the end surface of the cylinder main body 21 (see FIG. 2), the valve portion 31 is lifted away from the valve seat 23 and is thereby in the valve opening state. In contrast, when the valve portion 31 is moved in the axial direction from this state, the end surface of the valve umbrella tubular portion 42 is lifted away from the end surface of the cylinder main body 21, and the valve portion 31 contacts the valve seat 23 and is thereby in the valve closing state. Hereinafter, the moving direction of the valve element 30 at the time of valve opening of the valve element 30 will be referred to as a valve opening direction, and the moving direction of the valve element 30 at the time of valve closing of the valve element 30 will be referred to as a valve closing direction.

In the present embodiment, the valve umbrella 40 further includes a plurality of axial passages 401. The axial passages 401 are located on the radially outer side of the valve umbrella hole 43 and extend through the valve umbrella bottom portion 41 in the plate thickness direction. Specifically, each of the axial passages 401 is a passage that communicates between one surface of the valve umbrella 40, which is located on one side in the axial direction, and an opposite surface of the valve umbrella 40, which is located on the other side in the axial direction. The inside and the outside of the valve umbrella 40 are communicated with each other by the axial passages 401. The number of the axial passages 401 is three, and these axial passages 401 are arranged one after another at 90 degree intervals in the circumferential direction of the valve umbrella bottom portion 41 (see FIG. 3).

The armature 50 includes an armature bottom portion 51 and an armature tubular portion 52. The armature bottom portion 51 is shaped generally in a circular plate form and is made of a magnetic material (e.g., metal). The armature tubular portion 52 is formed integrally with the armature bottom portion 51 in one-piece such that the armature tubular portion 52 is shaped in a cylindrical tubular form and extends in the axial direction from an outer peripheral part (radially outer end part) of the armature bottom portion 51. Specifically, the armature tubular portion 52 is formed integrally with the armature bottom portion 51 in one-piece from the common material.

The armature 50 has an armature recess 511 that is recessed in a circular form at a center part of an end surface of the armature bottom portion 51, which is opposite to the armature tubular portion 52.

The armature 50 is configured to move relative to the valve element 30 while an inner peripheral wall 520 of the armature tubular portion 52 (serving as an inner peripheral wall of the armature 50) is slidable along an outer peripheral wall 420 of the valve umbrella tubular portion 42 (serving as an outer peripheral wall of the valve umbrella 40), and the armature bottom portion 51 of the armature 50 is configured to abut against the end surface of the flange 324, which is opposite to the valve portion 31, and the end surface of the small diameter portion 323, which is opposite to the diameter reducing portion 322 (collectively serving as an end surface of the valve element 30, which is opposite to the valve portion 31).

In the present embodiment, the armature 50 further includes a plurality of axial passages 501. The axial passages 501 are located on the radially outer side of the armature recess 511 and extend through the armature bottom portion 51 in a plate thickness direction (i.e., a direction perpendicular to a plane of the armature bottom portion 51). Specifically, each of the axial passages 501 is a passage that communicates between one surface of the armature 50, which is located on one side in the axial direction, and an opposite surface of the armature 50, which is located on the other side in the axial direction. The inside and the outside of the armature 50 are communicated with each other through the axial passages 501. The number of the axial passages 501 is four, and these axial passages 501 are arranged one after another in the circumferential direction of the armature bottom portion 51 at 90 degree intervals. The axial passages 501 are communicated with the axial passages 401 through an annular space that is formed between the valve umbrella bottom portion 41 and the armature bottom portion 51.

The inner stator 71 is shaped generally in a circular plate form and is made of a magnetic material (e.g., metal). The inner stator 71 is placed on a side of the armature 50, which is opposite to the valve element 30, such that the inner stator 71 is coaxial with the cylinder main body 21. The inner stator 71 has a stator recess 711 that is recessed in a circular form at a center part of an end surface of the inner stator 71, which is located on a side where the armature 50 is placed.

The electromagnetic valve 10 further includes a magnetic flux restrictor 72, an outer stator 73 and an outer stator 74. The magnetic flux restrictor 72 is shaped in a cylindrical tubular form and is made of a non-magnetic material (e.g., metal). The magnetic flux restrictor 72 is installed to the inner stator 71 such that the magnetic flux restrictor 72 is fitted into an annular groove that is formed at an outer peripheral part of an end surface of the inner stator 71, which is located on a side where the cylinder 20 is placed.

The outer stator 73 is made of a magnetic material (e.g., metal). The outer stator 73 includes a stator tubular portion 731 and a stator plate portion 732. The stator tubular portion 731 is shaped in a cylindrical tubular form. The stator plate portion 732 is formed integrally with the stator tubular portion 731 in one-piece such that the stator plate portion 732 is shaped in an annular plate form and radially outwardly extends from one end part of the stator tubular portion 731.

The outer stator 73 is installed such that an end surface of the stator tubular portion 731, which is opposite to the stator plate portion 732, contacts an end surface of the magnetic flux restrictor 72 located on a side where the cylinder 20 is placed, and an end surface of the stator plate portion 732, which is opposite to the magnetic flux restrictor 72, contacts the end surface of the cylinder main body 21, which is opposite to the pump body 11.

Here, the cylinder annular recess 24 is communicated with a space at an inside of the stator tubular portion 731 (see FIG. 2). Furthermore, an outer diameter of the armature bottom portion 51 and an outer diameter of the armature tubular portion 52 of the armature 50 are smaller than an inner diameter of the magnetic flux restrictor 72 and an inner diameter of the stator tubular portion 731. Therefore, a cylindrical gap is formed between the outer peripheral wall of the armature 50 and the inner peripheral wall of the stator tubular portion 731. Thereby, the armature 50 does not slide along the stator tubular portion 731 and the magnetic flux restrictor 72.

The outer stator 74 is made of a magnetic material (e.g., metal). The outer stator 74 includes a stator tubular portion 741 and a stator plate portion 742. The stator tubular portion 741 is shaped in a cylindrical tubular form. The stator plate portion 742 is formed integrally with the stator tubular portion 741 in one-piece such that the stator plate portion 742 is shaped in an annular plate form and radially inwardly extends from one end part of the stator tubular portion 741.

The outer stator 74 is installed such that an end surface of the stator tubular portion 741, which is opposite to the stator plate portion 742, contacts an outer peripheral part of an end surface of the stator plate portion 732, which is opposite to the cylinder 20, and an inner peripheral part of the stator plate portion 742 contacts an outer peripheral part of the inner stator 71.

The inner stator 71, the magnetic flux restrictor 72, the outer stator 73 and the outer stator 74 are integrated such that the inner stator 71, the magnetic flux restrictor 72, the outer stator 73 and the outer stator 74 are immovable relative to the cylinder 20.

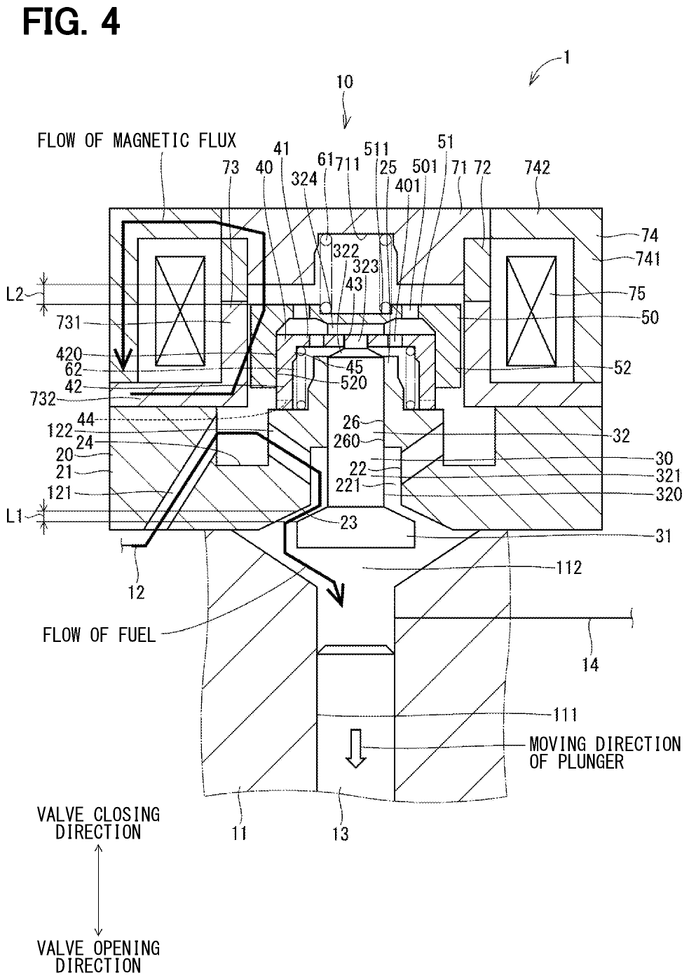

The coil 75 is shaped in a cylindrical tubular form and is placed in a cylindrical space defined by the magnetic flux restrictor 72, the outer stator 73 and the outer stator 74. The coil 75 is configured to generate a magnetic flux when the electric power is supplied to the coil 75. When the coil 75 generates the magnetic flux, a magnetic circuit is formed through the outer stator 73, the armature 50, the inner stator 71 and the outer stator 74 to conduct the magnetic flux while bypassing the magnetic flux restrictor 72 (see FIG. 4). Therefore, a magnetic attractive force is generated between the inner stator 71 and the armature 50, and thereby the armature 50 is magnetically attracted to the inner stator 71, i.e., is magnetically attracted in the valve closing direction. An electronic control unit (hereinafter referred to as an ECU) controls the electric power supply to the coil 75.

The armature spring 61 is, for example, a coil spring and is installed between the armature bottom portion 51 and the inner stator 71. One end part of the armature spring 61 contacts a bottom surface of the armature recess 511, and the other end of the armature spring 61 contacts a bottom surface of the stator recess 711. The armature spring 61 is compressed in the axial direction between the armature bottom portion 51 and the inner stator 71. Therefore, the armature spring 61 urges the armature 50 in the valve opening direction.

Radial movement of the one end part of the armature spring 61 is limited by the armature recess 511. Radial movement of the other end part of the armature spring 61 is limited by the stator recess 711.

The valve element spring 62 is, for example, a coil spring and is installed between the cylinder main body 21 and the valve umbrella bottom portion 41 at a location that is on a radially outer side of the cylinder projection 25. One end part of the valve element spring 62 contacts the end surface of the cylinder main body 21, which is opposite to the pump body 11, and the other end part of the valve element spring 62 contacts an end surface of the valve umbrella bottom portion 41, which is located on the side where the cylinder 20 is placed. The valve element spring 62 is compressed in the axial direction between the cylinder main body 21 and the valve umbrella bottom portion 41. Thus, the valve element spring 62 urges the valve umbrella 40 of the valve element 30 and the armature 50 in the valve closing direction.

The spring movement limiter 45 of the valve umbrella 40 contacts an outer peripheral surface of the other end part of the valve element spring 62, which is opposite to the cylinder 20. Thus, the spring movement limiter 45 can limit radial movement of the other end part of the valve element spring 62.

Furthermore, radial movement of the one end part of the valve element spring 62, which is located on the side where the cylinder main body 21 is placed, is limited by an outer peripheral wall of an end part of the cylinder projection 25, which is located on the side where the cylinder main body 21 is placed.

An urging force of the armature spring 61 is larger than an urging force of the valve element spring 62. Therefore, when the electric power is not supplied to the coil 75 (see FIG. 2), the armature 50 and the valve element 30 are urged in the valve opening direction. At this time, the center part of the armature bottom portion 51 is urged against the flange 324 of the valve element 30, and an end surface of the valve umbrella tubular portion 42 of the valve umbrella 40 is urged against the end surface of the cylinder main body 21. Next, the operations of the electromagnetic valve 10 and the high-pressure pump 1 will be described in detail.

### <Suction Stroke>

When the electric power supply to the coil 75 is stopped, the valve portion 31 is lifted away from the valve seat 23, i.e., is placed in the valve opening state. In this state, when the plunger 13 is moved toward the side, which is opposite to the pressurizing chamber 112, the volume of the pressurizing chamber 112 is increased, and the fuel, which is located on the side of the valve seat 23 that is opposite to the pressurizing chamber 112, i.e., the fuel in the fuel passage 221 is suctioned into the pressurizing chamber 112 (see FIG. 4).

### <Pressurization Stroke>

When the electric power is supplied to the coil 75, the magnetic flux is generated from the coil 75, and thereby the magnetic circuit is formed through the outer stator 73, the armature 50, the inner stator 71 and the outer stator 74 to conduct the magnetic flux while bypassing the magnetic flux restrictor 72 (see FIG. 4). Therefore, the magnetic attractive force is generated between the inner stator 71 and the armature 50, and thereby the armature 50 is magnetically attracted toward the inner stator 71, i.e., is magnetically attracted in the valve closing direction against the urging force of the armature spring 61. Furthermore, at this time, the valve element 30 is moved toward the inner stator 71, i.e., is moved in the valve closing direction by the urging force of the valve element spring 62.

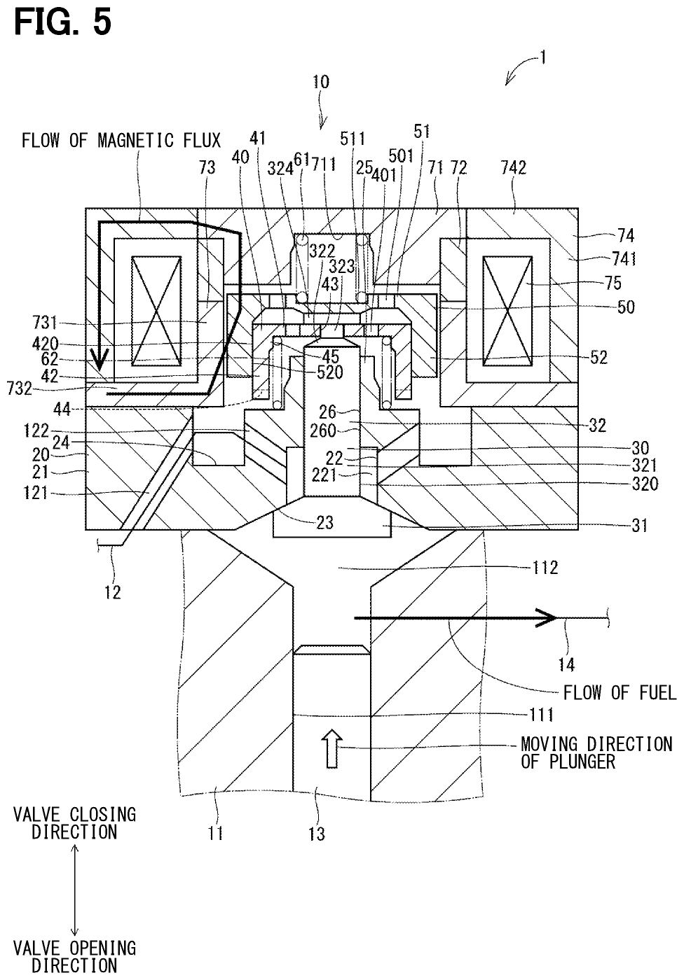

At this time, the armature 50 and the valve umbrella 40 integrally move toward the inner stator 71 (see FIGS. 4 and 5). Thus, at this time, there is no slide movement between the inner peripheral wall 520 of the armature 50 and the outer peripheral wall 420 of the valve umbrella 40 of the valve element 30.

When the valve portion 31 is seated against the valve seat 23 through the movement of the valve element 30 in the valve closing direction and is thereby placed in the valve closing state, the movement of the valve element 30 in the valve closing direction is limited (see FIG. 5).

When the plunger 13 is moved toward the pressurizing chamber 112 in the state where the valve element 30 is placed in the valve closing state, the volume of the pressurizing chamber 112 is decreased. Thus, the fuel in the pressurizing chamber 112 is compressed and is pressurized. When the pressure of the fuel in the pressurizing chamber 112 becomes equal to or larger than a valve opening pressure of the discharge valve 15, the discharge valve 15 is placed in a valve opening state. Thus, the fuel is discharged toward the pipe 102, i.e., toward the common rail 5 through the discharge passage 14.

In the valve closing state of the valve element 30, when the electric power supply to the coil 75 continues, the armature 50 is moved toward the inner stator 71, i.e., is moved in the valve closing direction by the magnetic attractive force generated between the armature 50 and the inner stator 71 against the urging force of the armature spring 61.

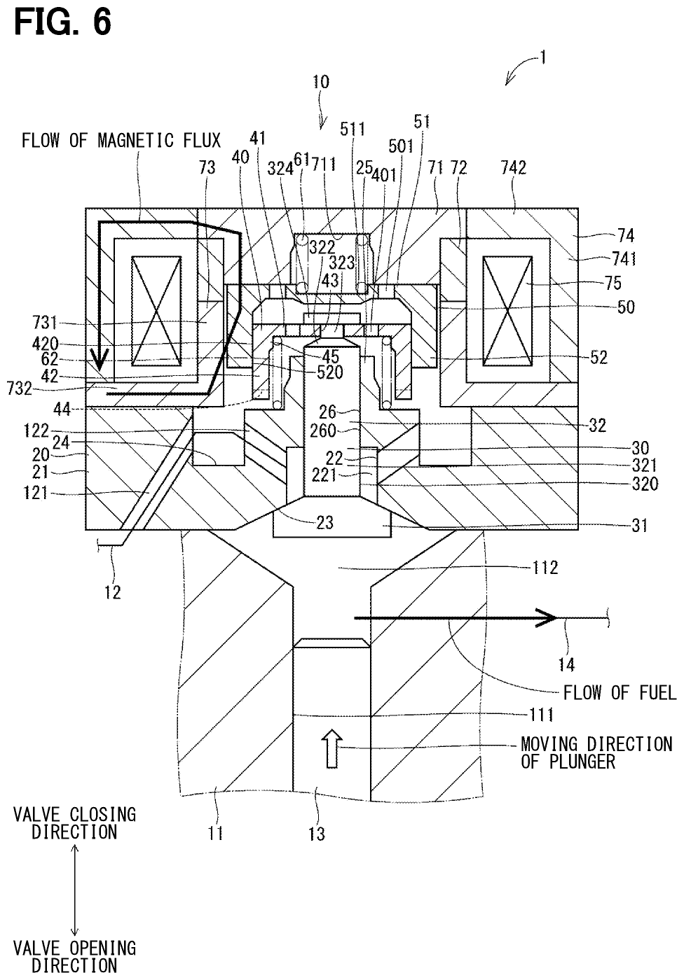

At this time, the armature 50 is moved relative to the valve umbrella 40 in the valve closing direction (see FIGS. 5 and 6). Thus, at this time, the slide movement occurs between the inner peripheral wall 520 of the armature 50 and the outer peripheral wall 420 of the valve umbrella 40 of the valve element 30.

When the armature bottom portion 51 abuts against the inner stator 71 through the movement of the armature 50 in the valve closing direction, the movement of the armature 50 in the valve closing direction is limited (see FIG. 6).

When the electric power supply to the coil 75 is stopped, the magnetic attractive force between the inner stator 71 and the armature 50 is lost. Thus, the armature 50 is urged in the valve opening direction by the urging force of the armature spring 61. When the armature bottom portion 51 abuts against the flange 324 of the valve element 30 through the movement of the armature 50 in the valve opening direction, the valve element 30 is urged in the valve opening direction by the urging force of the armature spring 61. Therefore, the valve element 30 is moved in the valve opening direction, and the valve portion 31 is lifted away from the valve seat 23 and is placed in the valve opening state.

The high-pressure pump 1 repeats the suction stroke and the pressurization stroke described above, so that the high-pressure pump 1 pressurizes the fuel suctioned into the pressurizing chamber 112 and discharges the pressurized fuel to the common rail 5. The supply amount of the fuel, which is supplied from the high-pressure pump 1 to the common rail 5, is adjusted by controlling, for example, the timing of supplying the electric power to the coil 75 of the electromagnetic valve 10.

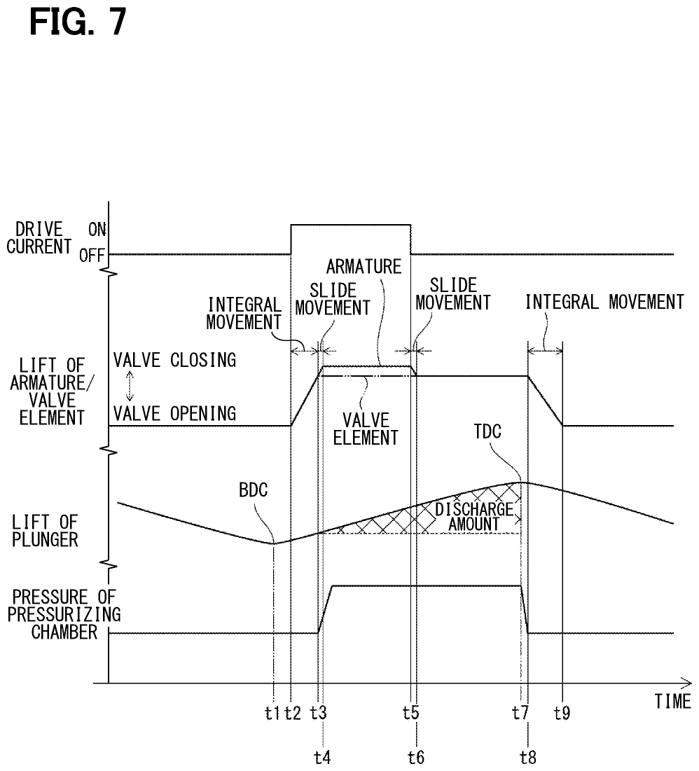

Next, the exemplary operations of the electromagnetic valve 10 and the high-pressure pump 1 will be described with reference to FIG. 7.

At time t1 after the start of the movement of the plunger 13 toward the side, which is opposite to the pressurizing chamber 112, the plunger 13 reaches a bottom dead center (BDC).

Then, at time t2 during the movement of the plunger 13 toward the pressurizing chamber 112 after the bottom dead center, the electric power supply to the coil 75 starts. Therefore, the magnetic attractive force is generated between the inner stator 71 and the armature 50. Thus, the integral movement of the armature 50 and the valve element 30 in the valve closing direction starts.

Then, at time t3, the valve portion 31 of the valve element 30 abuts against the valve seat 23 and is placed in the valve closing state. Thereby, the pressure of the pressurizing chamber 112 begins to increase. After the time t3, the fuel in the pressurizing chamber 112 is pressurized and is then discharged through the movement of the plunger 13 toward the pressurizing chamber 112.

Since the movement of the valve element 30 in the valve closing direction is limited through the abutment of the valve portion 31 against the valve seat 23 at the time t3, the armature 50 alone moves in the valve closing direction after the time t3. At this time, the inner peripheral wall 520 of the armature 50 is slid along the outer peripheral wall 420 of the valve umbrella 40 of the valve element 30.

Then, at time t4, the armature 50 contacts the inner stator 71, and thereby movement of the armature 50 in the valve closing direction is limited.

Thereafter, at time t5, the electric power supply to the coil 75 is stopped. Thus, after the time t5, the armature 50 is urged by the armature spring 61 and is thereby moved in the valve opening direction. At this time, the valve element 30 is held in the valve closing state by the pressure of the pressurizing chamber 112. Thus, the armature 50 alone moves in the valve opening direction, and the inner peripheral wall 520 of the armature 50 is slid along the outer peripheral wall 420 of the valve umbrella 40 of the valve element 30.

Then, at time t6, the armature bottom portion 51 of the armature 50 abuts against the flange 324 of the valve element 30. At this time, the valve element 30 is held in the valve closing state by the pressure of the pressurizing chamber 112. Thus, after the time t6, the armature 50 is held in the state where the armature bottom portion 51 abuts against the flange 324 of the valve element 30.

Then, at time t7, the plunger 13 reaches a top dead center (TDC). Thus, the pressure of the pressurizing chamber 112 begins to decrease. At this time, the discharge of the fuel from the pressurizing chamber 112 is terminated.

Thereafter, at time t8, the pressure of the pressurizing chamber 112 reaches a predetermined pressure, and the integral movement of the armature 50 and the valve element 30 in the valve opening direction starts. Then, at time t9, the valve umbrella tubular portion 42 of the valve umbrella 40 abuts against the cylinder main body 21, and the valve element 30 is placed in a full valve opening state. Furthermore, the movement of the valve element 30 and the armature 50 in the valve opening direction is limited.

As shown in FIG. 4, a distance L1 between the valve portion 31 and the valve seat 23 in the axial direction of the valve element 30 corresponds to a maximum lift amount of the valve element 30. Furthermore, a distance L2 between the armature bottom portion 51 and the inner stator 71 in the axial direction of the armature 50 corresponds to a maximum lift amount of the armature 50.

As shown in FIG. 2, in the present embodiment, the valve element 30, the armature 50 and the valve element spring 62 are placed such that a sliding range R1 between the cylinder 20 and the shaft 32, a sliding range R2 between the armature 50 and the valve umbrella 40, and an axial range R3 of the valve element spring 62 overlap with each other in the axial direction. Here, the sliding range R2 is defined as a range, in which the armature 50 and the valve umbrella 40 are slidable relative to each other. Also, the sliding range R2 is defined as a range, in which the armature 50 and the valve umbrella 40 are slidable relative to each other.

As described above, <1> in the present embodiment, the valve element 30 includes: the valve portion 31; the shaft 32, which extends from the valve portion 31 in the axial direction and has the outer peripheral wall 320 that is slidable along the inner peripheral wall 260 of the cylinder 20 while the shaft 32 is supported by the cylinder 20 so as to enable reciprocation of the shaft 32 in the axial direction; and the valve umbrella 40, which is formed integrally with the shaft 32 while the valve element 30 is configured to open or close the fuel passage 221 when the valve portion 31 is lifted away from the valve seat 23 or is seated against the valve seat 23. The armature 50 is configured to move relative to the valve element 30 while the inner peripheral wall 520 of the armature 50 is slidable along the outer peripheral wall 420 of the valve umbrella 40, and the armature 50 is configured to abut against the surface of the valve element 30, which is located on the side that is opposite to the valve portion 31.

In the present embodiment, when the armature 50 is magnetically attracted to the inner stator 71 through the electric power supply to the coil 75, the valve element 30 is urged in the valve closing direction by the valve element spring 62 and is moved together with the armature 50 in the valve closing direction. At this time, the slide movement does not occur between the inner peripheral wall 520 of the armature 50 and the outer peripheral wall 420 of the valve umbrella 40 of the valve element 30. When the valve portion 31 of the valve element 30 contacts the valve seat 23 and is placed in the valve closing state, the movement of the valve element 30 in the valve closing direction is limited. In this state, when the armature 50 is further magnetically attracted toward the inner stator 71, the armature 50 is moved relative to the valve element 30.

At this time, the inner peripheral wall 520 of the armature 50 is slid along the outer peripheral wall 420 of the valve umbrella 40 of the valve element 30. As discussed above, in the present embodiment, the slide movement between the inner peripheral wall 520 of the armature 50 and the outer peripheral wall 420 of the valve umbrella 40 of the valve element 30 occurs only when the relative movement occurs between the armature 50 and the valve element 30. Therefore, the slide distance between the members can be reduced in comparison to the previously proposed electromagnetic valve. Thereby, the wearing of the member(s) can be reduced.

Furthermore, in the present embodiment, the armature 50 and the valve element 30 are configured such that the slide movement occurs between the inner peripheral wall 520 of the armature 50 and the outer peripheral wall 420 of the valve umbrella 40 of the valve element 30. Thus, for the same L/D ratio (length to diameter ratio), it is possible to reduce L, which is the length measured in the axial direction, to allow a reduction in the axial size of the armature 50 in comparison to the conventional configuration, in which the slide movement occurs between the outer peripheral wall of the armature and the inner peripheral wall of the other member like in the conventional electromagnetic valve. Thereby, the size of the electromagnetic valve 10 can be reduced.

Furthermore, in the conventional electromagnetic valve discussed above, the valve element and the armature are respectively supported by the different members in a manner that enables axial reciprocation. Therefore, it may be difficult to align the axis of the valve element and the axis of the armature with each other.

In contrast, in the present embodiment, the inner peripheral wall 520 of the armature 50 is slid along the outer peripheral wall 420 of the valve umbrella 40 of the valve element 30, and the outer peripheral wall 320 of the shaft 32 of the valve element 30 is slid along the inner peripheral wall 260 of the cylinder 20. Therefore, the axial reciprocation of the valve element 30 is guided by the cylinder 20, and the axial reciprocation of the armature 50 is guided by the valve element 30 that is in turn guided by the cylinder 20. As discussed above, the axis of the armature 50 and the axis of the valve element 30 can be aligned by the cylinder 20, which is the common member that is commonly used to align the axis of the armature 50 and axis of the valve element 30.

Furthermore, <2> in the present embodiment, the valve element 30, the armature 50 and the valve element spring 62 are placed such that the sliding range R1 between the cylinder 20 and the shaft 32, the sliding range R2 between the armature 50 and the valve umbrella 40, and the axial range R3 of the valve element spring 62 overlap with each other in the axial direction.

Therefore, the axial size of the electromagnetic valve 10 can be further reduced. Furthermore, <3> in the present embodiment, at least one of the armature 50 and the valve umbrella 40 has the axial passages (at least one axial passage) that connect between one surface of the at least one of the armature 50 and the valve umbrella 40, which is located on the one side in the axial direction, and the other surface of the at least one of the armature 50 and the valve umbrella 40, which is located on the other side in the axial direction. In the present embodiment, the armature 50 has the axial passages 501, and the valve umbrella 40 has the axial passages 401.

The fuel around the armature 50 and the fuel around the valve umbrella 40 can flow through the axial passages 501 and the axial passages 401. Therefore, it is possible to limit occurrence of retention (stagnation) of fuel in the space inside the armature 50 and the space inside the valve umbrella 40, and also it is possible to limit occurrence of blockage of these spaces. Thereby, it is possible to limit deterioration of slidability between the members, which would be otherwise caused by deterioration of fuel. Moreover, the behavior of the valve element 30 can be stabilized. Furthermore, cavitation erosion on the surface of the member(s) can be limited.

Furthermore, <4>, in the present embodiment, the valve element 30 includes the spring movement limiter 45 that is located at the inner side of the valve umbrella 40 in the radial direction and is configured to limit movement of the valve element spring 62 in the radial direction.

Therefore, the inclination and fall of the valve element spring 62 can be limited. Thereby, the slide resistance between the members can be limited, and the slidability can be stabilized.

Furthermore, <5> in the present embodiment, at least one of the valve umbrella 40 and the cylinder 20 has the grooves (at least one groove) that are recessed in the axial direction at the contact part where the valve umbrella 40 and the cylinder 20 contact with each other when the valve umbrella 40 abuts against the cylinder 20. In the present embodiment, the valve umbrella 40 has the grooves 44 that are recessed in the axial direction at the end surface (serving as the contact part) of the valve umbrella tubular portion 42, which is opposite to the valve umbrella bottom portion 41 and contacts the cylinder 20.

Therefore, it is possible to reduce a linking force that is generated by a negative pressure exerted between the valve umbrella 40 and the cylinder 20 and acts as a force for pulling the valve umbrella 40 in an opposite direction, which is opposite to the moving direction of the valve umbrella 40 at the time of moving the valve element 30 in the valve closing direction from the valve opening state of the valve element 30. Thereby, the behavior of the valve element 30 can be stabilized at the initial stage of the valve closing process of the valve element 30.

Furthermore, <6> in the present embodiment, there is provided the high-pressure pump 1 that includes the electromagnetic valve 10, the pump body 11, the suction passage 122, the plunger 13 and the discharge passage 14. The pump body 11 has the pressurizing chamber 112 formed on the side of the fuel passage 221 where the valve seat 23 is placed. The suction passage 122 is communicated with the fuel passage 221 and is configured to conduct the fuel to be suctioned into the pressurizing chamber 112. The plunger 13 is configured to pressurize the fuel in the pressurizing chamber 112 through the reciprocation of the plunger 13 in the axial direction. The discharge passage 14 is configured to conduct the fuel, which is pressurized in the pressurizing chamber 112.

As discussed above, in the electromagnetic valve 10 of the present embodiment, the wearing of the member(s) can be reduced, and the axial size of the electromagnetic valve 10 can be reduced. Therefore, the high-pressure pump 1, which includes the electromagnetic valve 10, can reduce the wearing of the member(s) and can reduce the axial size. Thereby, the high-pressure pump 1 can be easily installed in the engine room where the installation requirements are severe.

### Second Embodiment

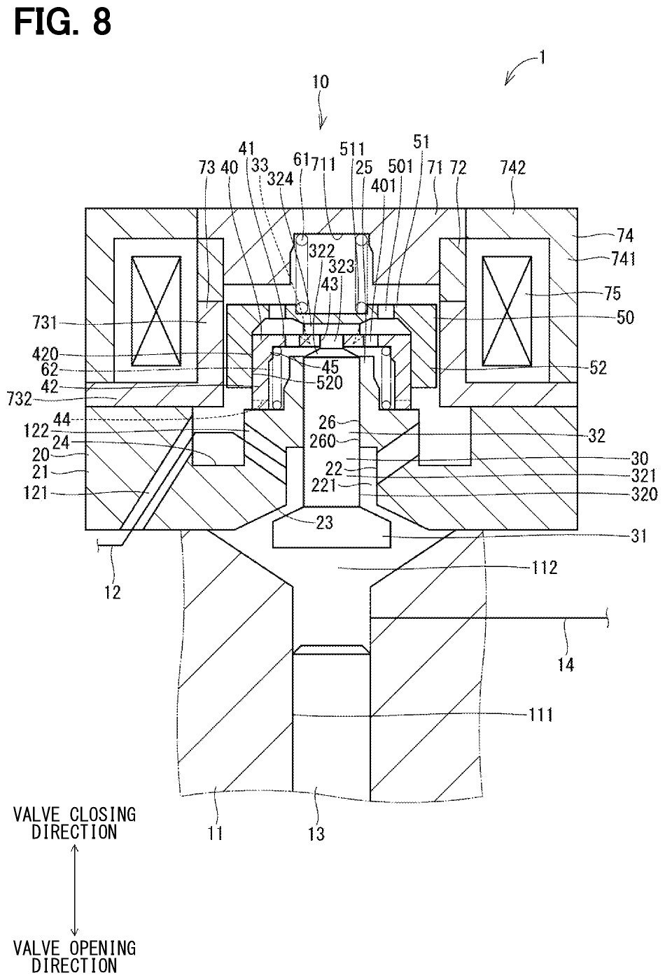

FIG. 8 shows an electromagnetic valve and a portion of a high-pressure pump according to a second embodiment. The second embodiment differs from the first embodiment with respect to the assembling method for assembling the valve element 30, the shaft 32 and the valve umbrella 40 together.

In the present embodiment, the shaft 32 and the valve umbrella 40 are assembled together by welding. Thus, the shaft 32 and the valve umbrella 40 are integrated together such that the shaft 32 and the valve umbrella 40 are not movable relative to each other.

Specifically, an outer peripheral part of the flange 324 of the shaft 32 is welded to a part of the valve umbrella bottom portion 41 of the valve umbrella 40, which is located on a radially outer side of the valve umbrella hole 43. Thereby, at this welded part, there is formed a melted and solidified part 33, which is formed through melting of the flange 324 and the valve umbrella bottom portion 41 and solidifying of the melted part.

Besides the above-described point, the present embodiment is the same as the first embodiment.

As described above, in the present embodiment, the shaft 32 and the valve umbrella 40 are fixed together by the welding. Therefore, it is possible to limit occurrence of rattling and tilting between the shaft 32 and the valve umbrella 40. Thus, the slidability between the inner peripheral wall 260 of the cylinder 20 and the outer peripheral wall 320 of the shaft 32 can be stabilized, and the slidability between the outer peripheral wall 420 of the valve umbrella 40 and the inner peripheral wall 520 of the armature 50 can be stabilized.

### Third Embodiment

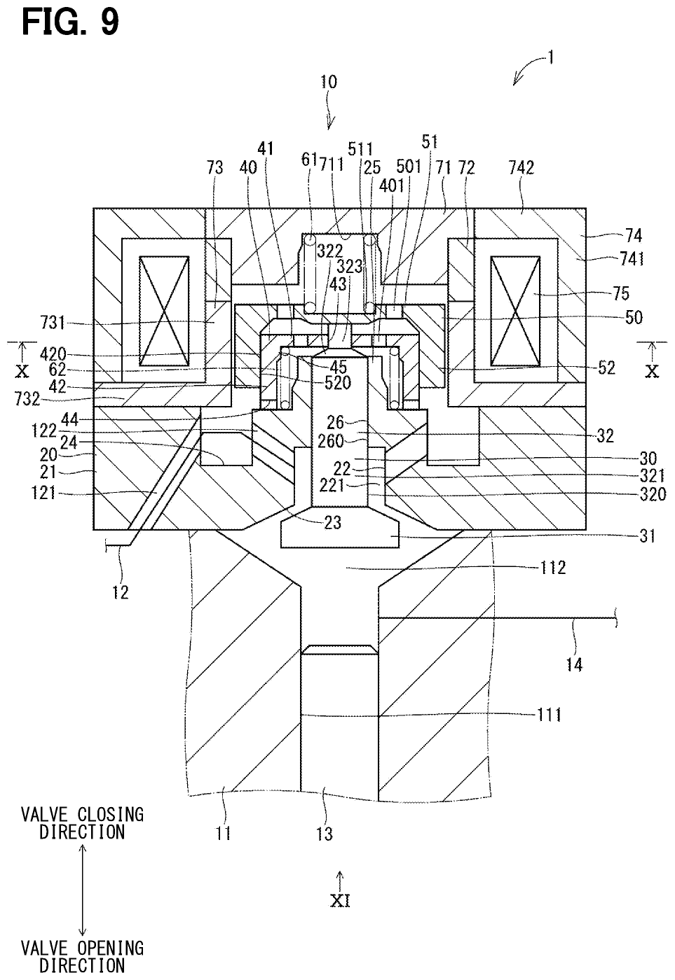

FIG. 9 shows an electromagnetic valve and a portion of a high-pressure pump according to a third embodiment. The third embodiment differs from the first embodiment with respect to the assembling method for assembling the shaft 32 of the valve element 30 and the valve umbrella 40 together.

In the present embodiment, the shaft 32 and the valve umbrella 40 are assembled together by press fitting.

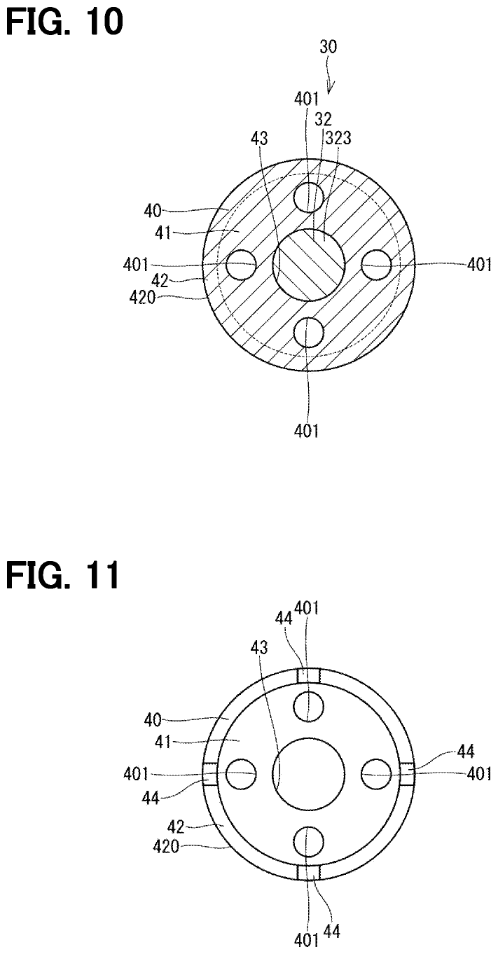

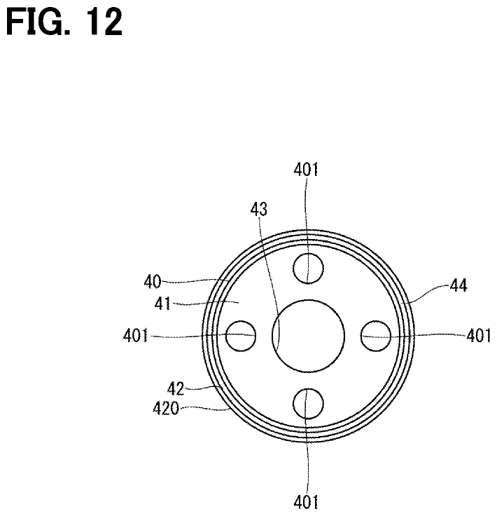

Specifically, the shaft 32 does not have the flange 324 discussed in the first embodiment. Furthermore, the valve umbrella 40 does not have the cutout 46 discussed in the first embodiment (see FIGS. 10 and 11).

An inner diameter of the valve umbrella hole 43 of the valve umbrella bottom portion 41 is slightly smaller than an outer diameter of the small diameter portion 323 of the shaft 32. The shaft 32 is assembled to the valve umbrella 40 by press fitting the small diameter portion 323 into the valve umbrella hole 43.

The armature 50 is configured such that the armature bottom portion 51 abuts against the end surface of the small diameter portion 323, which is opposite to the diameter reducing portion 322 (serving as the surface of the valve element 30, which is opposite to the valve portion 31).

The number of the axial passages 401 is four, and these axial passages 401 are arranged one after another at equal intervals in the circumferential direction of the valve umbrella bottom portion 41 (see FIGS. 10 and 11).

The number of the grooves 44 is four, and these grooves 44 are arranged one after another at equal intervals in the circumferential direction of the valve umbrella tubular portion 42. Specifically, the grooves 44 radially extend about the central axis of the valve umbrella tubular portion 42.

The valve umbrella 40 does not have the cutout 46, and thereby the inside of the valve umbrella 40 and the inside of the armature 50 may possibly become a closed space. However, in the present embodiment, the axial passages 401 and the axial passages 501 can avoid the formation of the closed space at the inside of the valve umbrella 40 and the inside of the armature 50. Therefore, similar to the first embodiment, it is possible to limit deterioration of slidability between the members, which would be otherwise caused by deterioration of fuel, and it is possible to stabilize the behavior of the valve element 30. Furthermore, it is possible to limit the cavitation erosion on the surface of the member(s).

Besides the above-described point, the present embodiment is the same as the first embodiment.

In the present embodiment, due to the presence of the grooves 44, it is possible to reduce the linking force that is generated by the negative pressure exerted between the valve umbrella 40 and the cylinder 20 and acts as the force for pulling the valve umbrella 40 in the opposite direction, which is opposite to the moving direction of the valve umbrella 40 at the time of moving the valve element 30 in the valve closing direction from the valve opening state of the valve element 30. Thereby, similar to the first embodiment, the behavior of the valve element 30 can be stabilized at the initial stage of the valve closing process of the valve element 30.

### Fourth Embodiment

FIG. 12 shows a portion of an electromagnetic valve according to a fourth embodiment. The fourth embodiment differs from the third embodiment with respect to the configuration of the valve umbrella 40 of the valve element 30.

In the present embodiment, the groove 44 is shaped in an annular form such that the groove 44 extends in the circumferential direction at the end surface of the valve umbrella tubular portion 42, which is opposite to the valve umbrella bottom portion 41.

Besides the above-described point, the present embodiment is the same as the third embodiment.

In the present embodiment, the groove 44 can limit the linking force generated between the valve umbrella 40 and the cylinder 20. Thereby, similar to the third embodiment, the behavior of the valve element 30 can be stabilized at the initial stage of the valve closing process of the valve element 30.

### Fifth Embodiment

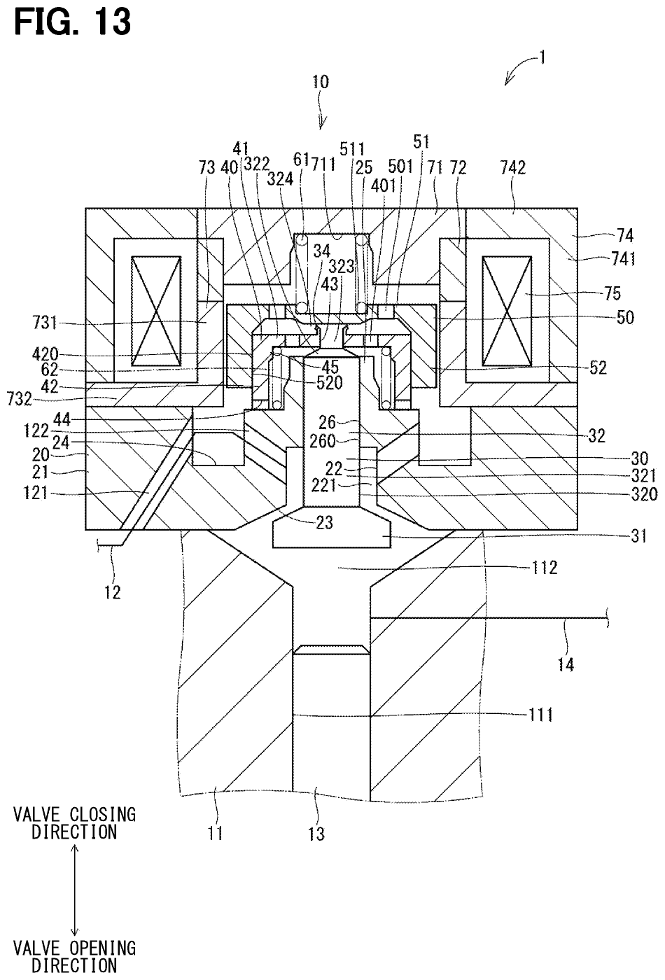

FIG. 13 shows an electromagnetic valve and a portion of a high-pressure pump according to a fifth embodiment. The fifth embodiment differs from the third embodiment with respect to the assembling method form assembling the shaft 32 of the valve element 30 and the valve umbrella 40 together.

In the present embodiment, the inner diameter of the valve umbrella hole 43 of the valve umbrella bottom portion 41 is generally the same as or is slightly larger than the outer diameter of the small diameter portion 323 of the shaft 32. The shaft 32 is assembled to the valve umbrella 40 as follows. Specifically, the small diameter portion 323 is inserted into the valve umbrella hole 43, and an end part of the small diameter portion 323, which is opposite to the diameter reducing portion 322, is swaged such that the end part of the small diameter portion 323 is radially outwardly deformed. In this way, a swaged part 34, which is a deformed part, is formed at the end part of the small diameter portion 323, which is opposite to the diameter reducing portion 322, and also at a peripheral part of the valve umbrella 40, which is located around the valve umbrella hole 43.

Besides the above-described point, the present embodiment is the same as the third embodiment.

### Sixth Embodiment

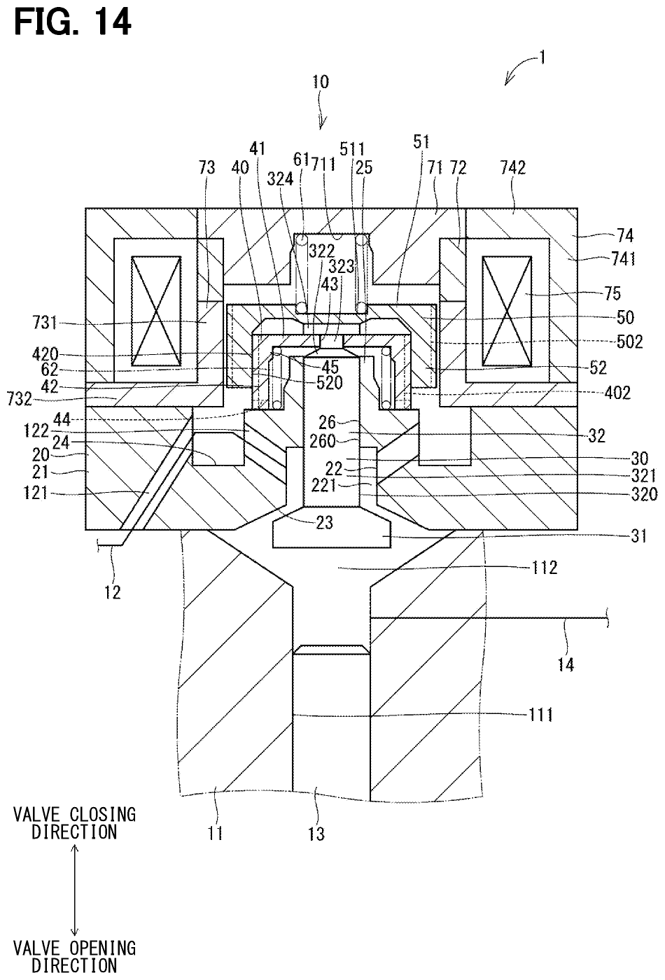

FIG. 14 shows an electromagnetic valve and a portion of a high-pressure pump according to a sixth embodiment. The sixth embodiment differs from the first embodiment with respect to the configurations of the valve umbrella 40 and the armature 50.

In the present embodiment, the valve umbrella 40 includes a plurality of axial passages 402 in place of the axial passages 401. Each of the axial passages 402 is formed such that the axial passage 402 is radially inwardly recessed from the outer peripheral wall 420 of the valve umbrella tubular portion 42 and extends in parallel with the axis of the valve umbrella tubular portion 42. Each of the axial passages 402 is formed to connect between the one end surface and the other end surface of the valve umbrella tubular portion 42 in the axial direction. The number of the axial passages 402 is four, and these axial passages 402 are arranged one after another at equal intervals in the circumferential direction of the valve umbrella tubular portion 42.

The armature 50 includes a plurality of axial passages 502 in place of the axial passages 501. Each of the axial passages 502 is formed such that the axial passage 502 is radially inwardly recessed from the outer peripheral wall of the armature tubular portion 52 and extends in parallel with the axis of the armature tubular portion 52. Each of the axial passages 502 is formed to connect between the one end surface and the other end surface of the armature tubular portion 52 in the axial direction. The number of the axial passages 502 is four, and these axial passages 502 are arranged one after another at equal intervals in the circumferential direction of the armature tubular portion 52.

Besides the above-described point, the present embodiment is the same as the first embodiment.

As described above, <3> in the present embodiment, at least one of the armature 50 and the valve umbrella 40 has the axial passages (at least one axial passage) that connect between one surface of the at least one of the armature 50 and the valve umbrella 40, which is located on the one side in the axial direction, and the other surface of the at least one of the armature 50 and the valve umbrella 40, which is located on the other side in the axial direction. In the present embodiment, the armature 50 has the axial passages 502, and the valve umbrella 40 has the axial passages 402.

The fuel around the armature 50 and the fuel around the valve umbrella 40 can flow through the axial passages 502 and the axial passages 402. Therefore, it is possible to limit occurrence of retention (stagnation) of the fuel in the space inside the armature 50 and the space inside the valve umbrella 40, and also it is possible to limit occurrence of blockage of these spaces. Thereby, like in the first embodiment, it is possible to limit deterioration of slidability between the members, which would be otherwise caused by deterioration of fuel. Moreover, the behavior of the valve element 30 can be stabilized. Furthermore, it is possible to limit the cavitation erosion on the surface of the member(s).

### Seventh Embodiment

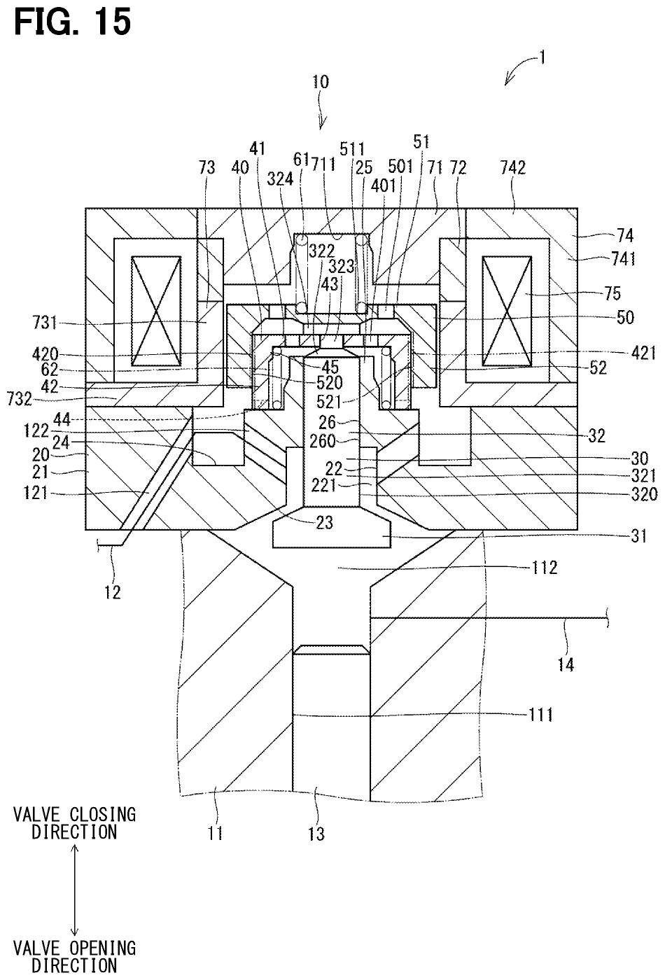

FIG. 15 shows an electromagnetic valve and a portion of a high-pressure pump according to a seventh embodiment. The seventh embodiment differs from the first embodiment with respect to the configurations of the valve umbrella 40 and the armature 50.

In the present embodiment, the valve umbrella 40 has a surface-treated portion 421. The surface-treated portion 421 is formed over an entire circumferential range and an entire axial range of the outer peripheral wall 420 of the valve umbrella tubular portion 42. A surface treatment, such as plating or diamond-like carbon (DLC) coating, is applied to the surface-treated portion 421.

The armature 50 has a surface-treated portion 521. The surface-treated portion 521 is formed over an entire circumferential range of the inner peripheral wall 520 of the armature tubular portion 52 and an axial range of the inner peripheral wall 520 that is from one end part of the inner peripheral wall 520, which is located on the cylinder main body 21 side, to the other end part of the inner peripheral wall 520, which is located on the armature bottom portion 51 side. A surface treatment, such as plating or diamond-like carbon (DLC) coating, is applied to the surface-treated portion 521.

Besides the above-described point, the present embodiment is the same as the first embodiment.

As discussed above, in the present embodiment, the outer peripheral wall 420 of the valve umbrella 40 and the inner peripheral wall 520 of the armature 50, which are slidable with each other, respectively have the surface-treated portion 421 and the surface-treated portion 521, at each of which the surface treatment, such as the plating, is applied.

Therefore, the slidability between the valve umbrella 40 and the armature 50 can be improved.

### Eighth Embodiment

An electromagnetic valve according to an eighth embodiment will be described. The eighth embodiment differs from the seventh embodiment with respect to the configurations of the valve umbrella 40 and the armature 50.

In the present embodiment, a heat treatment for implementing surface hardening is applied to the surface-treated portion 421 of the valve umbrella 40 in place of the surface treatment, such as the plating. Furthermore, a heat treatment for implementing surface hardening is applied to the surface-treated portion 521 of the armature 50 in place of the surface treatment, such as the plating.

Besides the above-described point, the present embodiment is the same as the seventh embodiment.

As discussed above, in the present embodiment, the outer peripheral wall 420 of the valve umbrella 40 and the inner peripheral wall 520 of the armature 50, which are slidable with each other, respectively have the surface-treated portion 421 and the surface-treated portion 521, at each of which the heat treatment for implementing surface hardening is applied.

Therefore, the wearing, which is caused by sliding between the outer peripheral wall 420 of the valve umbrella 40 and the inner peripheral wall 520 of the armature 50, can be limited.

### Ninth Embodiment

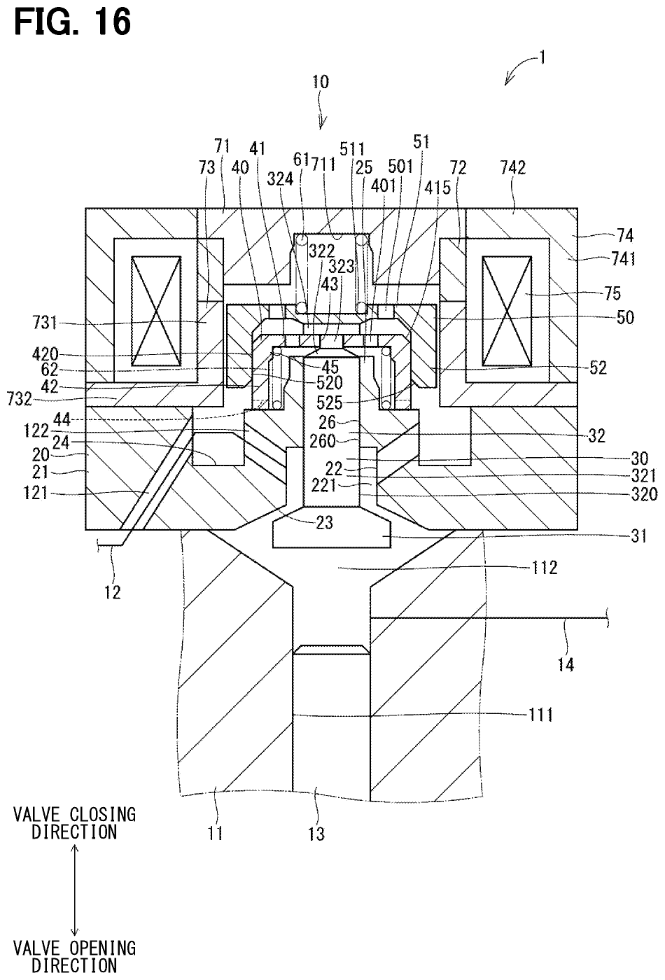

FIG. 16 shows an electromagnetic valve and a portion of a high-pressure pump according to a ninth embodiment. The ninth embodiment differs from the first embodiment with respect to the configurations of the valve umbrella 40 and the armature 50.

In the present embodiment, the valve umbrella 40 has a chamfered portion 415. The chamfered portion 415 is shaped in a tapered form at an outer peripheral part of the end surface of the valve umbrella tubular portion 42, which is located on the side where the armature bottom portion 51 is placed.

The armature 50 has a chamfered portion 525. The chamfered portion 525 is shaped in a tapered form at an inner peripheral part of the end surface of the armature tubular portion 52, which is located on the side that is opposite to the armature bottom portion 51.

Besides the above-described point, the present embodiment is the same as the first embodiment.

As discussed above, in the present embodiment, the outer peripheral wall 420 of the valve umbrella 40 and the inner peripheral wall 520 of the armature 50, which are slidable with each other, respectively have the chamfered portion 415 formed at the axial end part of the outer peripheral wall 420 of the valve umbrella 40 and the chamfered portion 525 formed at the axial end part of the inner peripheral wall 520 of the armature 50.

Therefore, prying between the corner of the end part of the valve umbrella tubular portion 42 and the inner peripheral wall 520 of the armature 50 can be limited, and prying between the corner of the end part of the armature tubular portion 52 and the outer peripheral wall 420 of the valve umbrella 40 can be limited. Therefore, the slidability between the valve umbrella 40 and the armature 50 can be improved.

### Tenth Embodiment

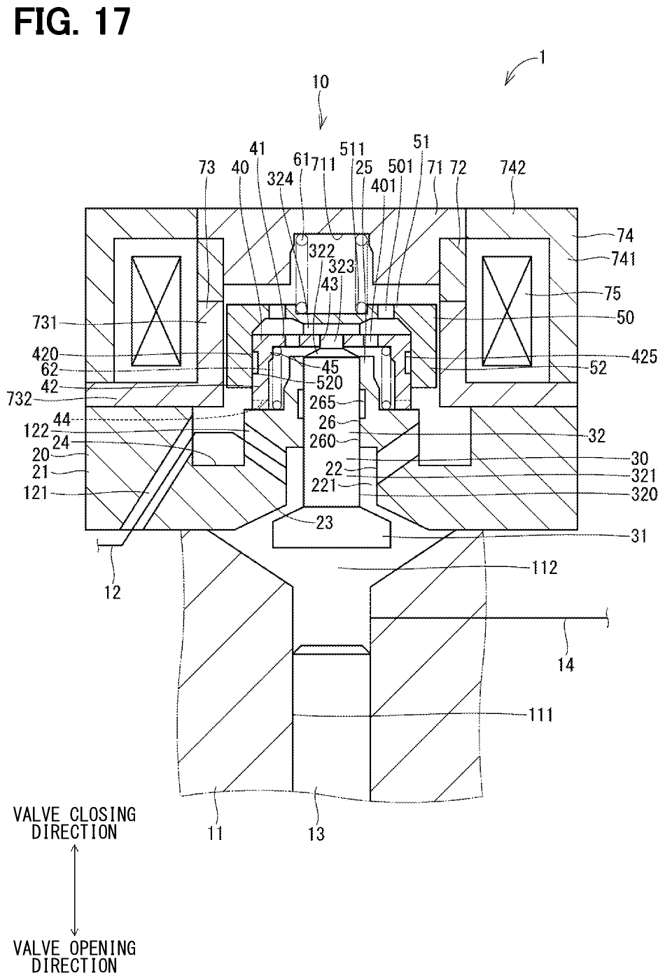

FIG. 17 shows an electromagnetic valve and a portion of a high-pressure pump according to a tenth embodiment. The tenth embodiment differs from the first embodiment with respect to the configurations of the cylinder 20 and the valve umbrella 40.

In the present embodiment, the cylinder 20 has a hollow groove 265. The hollow groove 265 is shaped generally in a cylindrical tubular form and is outwardly recessed from the inner peripheral wall 260 of the cylinder shaft hole 26 in the radial direction. The hollow groove 265 is partially formed at an axial part of the cylinder shaft hole 26 such that the hollow groove 265 is formed across a connection between the cylinder main body 21 and the cylinder projection 25. Therefore, the sliding range R1 between the cylinder 20 and the shaft 32 is smaller than that of the first embodiment.

The valve umbrella 40 further includes a hollow groove 425. The hollow groove 425 is shaped generally in a cylindrical tubular form and is inwardly recessed from the outer peripheral wall 420 of the valve umbrella tubular portion 42 in the radial direction. The hollow groove 425 is partially formed in an axial part of the outer peripheral wall 420 of the valve umbrella tubular portion 42. Therefore, the sliding range R2 between the armature 50 and the valve umbrella 40 is reduced in comparison to that of the first embodiment.

Besides the above-described point, the present embodiment is the same as the first embodiment.

As discussed above, in the present embodiment, the hollow groove 265 is formed at the inner peripheral wall 260 of the cylinder shaft hole 26. Furthermore, the hollow groove 425 is formed at the outer peripheral wall 420 of the valve umbrella tubular portion 42.

Therefore, it is possible to reduce the slide resistance between the inner peripheral wall 260 of the cylinder 20 and the outer peripheral wall 320 of the shaft 32, which slid relative to each other, and it is possible to reduce the slide resistance between the outer peripheral wall 420 of the valve umbrella tubular portion 42 and the inner peripheral wall 520 of the armature tubular portion 52, which slide relative to each other. Furthermore, due to the formation of the hollow groove 265 and the hollow groove 425, adhesion of deposits can be limited.

### Other Embodiments

In the above embodiments, there is described the example where the valve element 30, the armature 50 and the valve element spring 62 are placed such that the sliding range R1 between the cylinder 20 and the shaft 32, the sliding range R2 between the armature 50 and the valve umbrella 40, and the axial range R3 of the valve element spring 62 overlap with each other in the axial direction. Alternatively, in another embodiment, the sliding range R1, the sliding range R2 and the range R3 may not overlap with each other in the axial direction. Furthermore, any two of the sliding range R1, the sliding range R2 and the range R3 may overlap with each other in the axial direction.

Furthermore, in another embodiment, a size of the sliding range R1, a size of the sliding range R2 and a size of the overlapping range between the sliding range R1 and the sliding range R2 may be adjusted by, for example, increasing the inner diameter of the cylinder shaft hole 26 at one axial end side thereof and/or reducing the outer diameter of the valve umbrella tubular portion 42 at one axial end side thereof.

For example, in another embodiment, the valve element 30, the armature 50 and the valve element spring 62 may be configured such that the sliding range R1 and the range R3 overlap with each other in the axial direction, and the sliding range R2 and the range R3 overlap with each other in the axial direction. In this case, the sliding range R1 and the sliding range R2 may not overlap with each other in the axial direction.

Furthermore, in another embodiment, the valve element 30 and the armature 50 may be configured such that the sliding range R1 and the sliding range R2 do not overlap with each other.

Furthermore, in another embodiment, the valve element 30 and the valve element spring 62 may be configured such that the sliding range R1 and the range R3 overlap with each other in the axial direction. In this case, the sliding range R2 and the range R3 may not overlap with each other in the axial direction.

Furthermore, in another embodiment, the armature 50 and the valve element spring 62 may be configured such that the sliding range R2 and the range R3 overlap with each other in the axial direction. In this case, the sliding range R1 and the range R3 may not overlap with each other in the axial direction.

Furthermore, in another embodiment, as long as the axial passages 401, 402 are formed to connect between the one surface and the other surface of the valve umbrella 40, the configuration of the respective axial passages 401, 402 is not necessarily limited to the hole or the groove and may be changed to another configuration, such as a cutout, and the number of the axial passages 401, 402 may be set to any number. Furthermore, as long as the axial passages 501, 502 are formed to connect between the one surface and the other surface of the armature 50, the configuration of the respective axial passages 501, 502 is not necessarily limited to the hole or the groove and may be changed to another configuration, such as a cutout, and the number of the axial passages 501, 502 may be set to any number.

Furthermore, in another embodiment, the axial passages may be formed at only one of the armature 50 and the valve umbrella 40.

Furthermore, in another embodiment, both of the armature 50 and the valve umbrella 40 may not have the axial passages.

Furthermore, in another embodiment, the valve element 30 may not include the spring movement limiter 45.

Furthermore, in the above embodiments, there is described the example where the grooves 44 are formed at the end surface of the valve umbrella tubular portion 42, which is opposite to the valve umbrella bottom portion 41. Alternatively, in another embodiment, the cylinder 20 may include grooves that are formed at the contact part between the cylinder 20 and the valve umbrella 40 and are recessed in the axial direction. In this way, like in the case of forming the grooves 44 at the valve umbrella 40, it is possible to reduce the linking force generated between the valve umbrella 40 and the cylinder 20, and it is possible to stabilize the behavior of the valve element 30 at the valve closing process initial stage.

Furthermore, in another embodiment, both of the valve umbrella 40 and the cylinder 20 may not have the grooves.

Furthermore, in the seventh and eighth embodiments, there is described the example where the valve umbrella 40 and the armature 50 have the surface-treated portion 421 and the surface-treated portion 521, respectively. Alternatively, in another embodiment, the surface-treated portion may be formed at only one of the valve umbrella 40 and the armature 50.

Furthermore, in the ninth embodiment, there is described the example where the valve umbrella 40 and the armature 50 have the chamfered portion 415 and the chamfered portion 525, respectively. Alternatively, in another embodiment, the chamfered portion may be formed at only one of the valve umbrella 40 and the armature 50.

Furthermore, in the tenth embodiment, there is described the example where the cylinder 20 and the valve umbrella 40 have the hollow groove 265 and the hollow groove 425, respectively. Alternatively, in another embodiment, the hollow groove may be formed at only one of the cylinder 20 and the valve umbrella 40.

Furthermore, in another embodiment, the hollow groove may be formed such that the hollow groove is inwardly recessed from the outer peripheral wall 320 of the shaft 32 in the radial direction. Furthermore, the hollow groove may be formed such that the hollow groove is outwardly recessed from the inner peripheral wall 520 of the armature tubular portion 52 in the radial direction.

The application of the electromagnetic valve of the present disclosure is not necessarily limited to the high-pressure pump installed to the vehicle, and the electromagnetic valve of the present disclosure may be applied to a device that needs to open and close a liquid passage, which conducts the liquid, such as another type of pump or a device that processes liquid.

As described above, the present disclosure is not necessarily limited to the above-described embodiments and may be implemented in various forms without departing from the gist thereof.

What is claimed is:

1. An electromagnetic valve comprising:
a cylinder that includes:
a liquid passage, which is configured to conduct liquid; and
a valve seat, which is formed around the liquid passage;
a valve element that includes:
a valve portion;
a shaft, which extends from the valve portion in an axial direction and has an outer peripheral wall that is slidable along an inner peripheral wall of the cylinder, wherein the shaft is supported by the cylinder so as to enable reciprocation of the shaft in the axial direction; and
a valve umbrella, which is formed integrally with the shaft, wherein the valve element is configured to open or close the liquid passage when the valve portion is lifted away from the valve seat in a valve opening direction or is seated against the valve seat in a valve closing direction;
an armature that is configured to move relative to the valve element while an inner peripheral wall of the armature is slidable along an outer peripheral wall of the valve umbrella, wherein the armature is configured to abut against a surface of the valve element, which is located on a side that is opposite to the valve portion;
an armature spring that is configured to urge the armature in the valve opening direction;
a valve element spring that is configured to urge the valve element in the valve closing direction;
a stator that is located on a side of the armature, which is opposite to the valve element; and
a coil that is configured to generate a magnetic flux to magnetically attract the armature toward the stator when the coil is energized.

2. The electromagnetic valve according to claim 1, wherein the valve element, the armature and the valve element spring are placed such that a sliding range between the cylinder and the shaft, a sliding range between the armature and the valve umbrella, and an axial range of the valve element spring overlap with each other in the axial direction.

3. The electromagnetic valve according to claim 1, wherein at least one of the armature and the valve umbrella has at least one axial passage that connects between one surface of the at least one of the armature and the valve umbrella, which is located on one side in the axial direction, and another surface of the at least one of the armature and the valve umbrella, which is located on another side in the axial direction.

4. The electromagnetic valve according to claim 1, wherein the valve element includes a spring movement limiter that is located at an inner side of the valve umbrella in a radial direction and is configured to limit movement of the valve element spring in the radial direction.

5. The electromagnetic valve according to claim 1, wherein at least one of the valve umbrella and the cylinder has at least one groove that is recessed in the axial direction at a contact part where the valve umbrella and the cylinder contact with each other when the valve umbrella abuts against the cylinder.

6. A high-pressure pump comprising:
the electromagnetic valve of claim 1;
a pump body that has a pressurizing chamber while the pressurizing chamber is formed on a side of the liquid passage where the valve seat is placed;
a suction passage that is communicated with the liquid passage and is configured to conduct fuel to be suctioned into the pressurizing chamber;
a plunger that is configured to pressurize the fuel in the pressurizing chamber through reciprocation of the plunger in the axial direction; and
a discharge passage that is configured to conduct the fuel, which is pressurized in the pressurizing chamber.
